(19) United States
(12) Patent Application Publication
(10) Pub. No.: US 2023/0289566 A1
(43) Pub. Date: Sep. 14, 2023

(54) System and Method for Processing Information Signals

(71) Applicant: Bayerische Motoren Werke Aktiengesellschaft, Muenchen (DE)

(72) Inventor: Andreas Heimrath, Emmering (DE)

(21) Appl. No.: 18/008,351

(22) PCT Filed: Jul. 9, 2021
(86) PCT No.: PCT/EP2021/069179

§ 371 Date: Dec. 5, 2022

(30) Foreign Application Priority Data
Jul. 27, 2020 (DE) 10 2020 119 743.8

(51) Int. Cl. G06N 3/0464

(52) U.S. Cl. CPC G06N 3/0464

(57) ABSTRACT

A system for processing at least a first information signal and a second information signal includes a shared unit and at least two separate units of a neural network. A signal input receives the first information signal and the second information signal. The shared unit performs a respective first signal processing step of the first information signal and the second information signal. The least two separate units of the neural network are arranged in the signal flow downstream of the shared unit. The first unit of the at least two separate units performs a second signal processing step of the first information signal, and the second unit of the at least two separate units performs a second signal processing step of the second information signal, in order to generate processed information signals. A signal output provides the processed information signals.

The present application is the U.S. national phase of PCT Application PCT/EP2021/069179 filed on Jul. 9, 2021, which claims priority of German patent application No. 102020119743.8 filed on Jul. 27, 2020, which is incorporated herein by reference in its entirety.

### TECHNICAL FIELD

Exemplary embodiments relate to a system for processing at least a first and a second information signal, and a system for processing an information signal. Further exemplary embodiments relate to a sensor system and a motor vehicle. A method for the signal processing of an information signal is further proposed.

### BACKGROUND

In modern motor vehicles, there is a requirement to process a multiplicity of information signals, e.g. sensor signals of different types. Such signals can be used for different functions in the vehicle.

Signal processing using artificial intelligence, for example, is known. The concept of machine learning (e.g. supervised and unsupervised for clustering) and convolutional neural networks (CNN), inter alia, are known, e.g. in the field of computer vision for object recognition, object classification, and segmentation. Neural networks can be implemented e.g. in hardware.

CNN hardware accelerators, for example, are known which, e.g. in contrast to software-based CNN systems, can have positive effects on processing speed. One aim can be maximum computing power with minimal utilization of hardware resources. For example, a desired performance (e.g. the desired number of processed images per second) can be achieved in this way. The processor space, for example, and therefore costs can further be reduced in this way.

However, an energy need for the high functional requirements in known systems, particularly in the vehicle sector, can still be too high. Hardware-implemented neural networks, for example, can no longer be trained and are therefore less flexibly usable.

### SUMMARY

An object of the present disclosure is to provide improved concepts for systems having neural networks.

This object is achieved according to the subject-matter of the independent patent claims. Further advantageous embodiments are described in the dependent patent claims, the following description and in conjunction with the figures.

A system for processing at least a first and a second information signal is accordingly proposed. The system comprises a signal input for receiving the information signals and a shared unit of a neural network of the system. The shared unit of the neural network is designed for a respective first signal processing step of the information signals. The system further comprises at least two separate units of the neural network arranged in the signal flow downstream of the shared unit. A first unit of the least two separate units is designed for a second signal processing step of the first information signal and a second unit of the at least two separate units is designed for a second signal processing step of the second information signal. A signal output of the system is designed to output the processed information signals.

The system thus comprises a plurality of separate units of a neural network. The proposed system can enable a more efficient design of the signal processing. The shared unit of the neural network can thus be used to process both the first and the second information signal. The first signal processing step of the shared-use unit can be suitable e.g. for both the first and the second information signal.

The system offers the facility to select, following the first signal processing step, whether the signal is to be further processed in the second signal processing step by means of the first or the second unit of the two separate units. Different requirements for processing different information signals, for example, can thereby be met. The first unit of the separate units can be designed, for example, to process the signal differently from the second unit of the separate units.

Shared use of a part of the neural network (e.g. shared use of layers of the neural network) can be enabled in this way, so that this part does not have to be provided in duplicate as in other systems. A general signal processing, for example, can be performed by means of the shared unit, while the separate units (e.g. two or more separate units, e.g. at least three or at least four separate units, e.g. for increased system flexibility) can carry out more specific signal processing steps. The shared unit, for example, in conjunction with the first unit of the two separate units, can be regarded as a first neural network of the system, and the shared unit in conjunction with the second unit of the two separate units can be regarded as a second neural network of the system.

The two information signals can be e.g. two different signals, e.g. from at least two different signal devices. Signal devices of this type can be e.g. sensors, such as cameras, etc. This can enable the system, for example, to carry out general signal processing steps of the camera images in the first, shared part of the neural network and to carry out more specific steps (e.g. specific functions; e.g. specific processing appropriate to a camera type that is used) in the downstream, separated part of the neural network.

It can be provided, for example, that the at least two separate units of the neural network comprise at least one software-implemented unit of the neural network and at least one hardware-implemented unit of the neural network. The respective advantage, for example, of a software and hardware implementation can thereby be achieved simultaneously in the system. A hardware implementation can result in less flexibility in the signal processing, but can advantageously enable e.g. a higher processing speed and/or lower energy requirement in the processing. Conversely, a software implementation can enable greater flexibility, e.g. through reprogramming of the processing parameters (e.g. weightings of the neural network), even retrospectively, e.g. during a use of the system. The first separate unit can be used e.g. for predefined, unchanging functions, whereas the second separate unit can also be used if an adaptation to new functions is required.

It can be provided, for example, that the at least two separate units of the neural network are arranged in parallel in the signal flow. As a result, in the second signal processing step before the processing of the two information signals, it is possible for the at least two separate units to select the separate unit which is to be used. The selection can be made e.g. depending on a type of the information signal and/or a function to be performed by the system. The choice of the processing path can be controlled e.g. depending on the signal source (e.g. the sensor, e.g. the camera) from which the first or second information signal originates.

It can be provided, for example, that the shared unit of the neural network is hardware-implemented. The hardware implementation of the shared units can be used, for example, in an efficient manner for more general signal processing steps (e.g. a signal processing by means of the neural network; e.g. extraction of general features from the information signals). Signal processing steps of this type can be required e.g. for signals from different sensors before more specific signal processing steps adapted to the respective sensor can follow.

It can be provided, for example, that the shared unit of the neural network comprises a convolutional neural network (CNN for short; e.g. a deep convolutional neural network). A convolutional neural network can comprise one or more convolutional layers which can be followed e.g. by a pooling layer. The CNN can be used, for example, to perform classification functions (e.g. to extract features from images), e.g. for image recognition or voice recognition.

It can be provided, for example, that the shared unit of the neural network comprises an autoencoder or a part of an autoencoder. An autoencoder can be used to enable more efficient coding. The aim of an autoencoder can be data reduction, e.g. it can be used for dimension reduction. The autoencoder can comprise an input layer and at least one further layer which is significantly smaller than the input layer (the encoding-forming layer; e.g. encoding layer). The encoding layer can be used to output the signal processed in the first signal processing step from the shared unit. This allows the system to be used for data compression (e.g. compressed sensor data).

According to one exemplary embodiment, it can be provided that the system further comprises e.g. a preprocessing unit. It can be provided that the preprocessing unit is arranged in the signal flow between the signal input and the shared unit of the neural network. The preprocessing unit is designed, in particular, to allocate a respective processing time to the information signals for the first signal processing step. A scheduling, for example, must be provided (e.g. indicating when the first signal can be processed and when—e.g. subsequently—the second signal can be processed), since the shared unit is used for the signal processing of the first and second information signal (and further signals from e.g. two separate signal sources). A sequential processing of the information signals, for example, can be provided (e.g. in the order of arrival at the signal input of the system; e.g. alternate processing of signals from different signal sources). Alternatively or additionally, for example, prioritizations of the information signals can be taken into account. It may be appropriate, for example, to process more important signal types first, even if further lower-priority signals to be processed are held in a queue upstream of the shared unit of the neural network. Two cameras of a vehicle, for example, can feed images into the system (e.g. a first information signal from the first camera and a second information signal from the second camera). One of the cameras can be used, for example, for more safety-relevant tasks than the other of the cameras. Priority can be given to the processing of information signals from this camera for more safety-relevant tasks.

It can be provided, for example, that the processing unit is designed to convert the information signals to the signal standard which is adapted to the shared unit of the neural network. The preprocessing unit can thus enable an adaptation of signals from different signal sources (e.g. different cameras with different resolutions and/or a different frame rate), so that the signals from all different signal sources (e.g. sensors) can be processed equally by means of the shared unit.

It can be provided accordingly, for example, that the first and the second information signal are in each case image signals and the preprocessing unit is designed to convert the image signals into respective standard image signals with a predetermined frame rate and/or a predetermined image resolution.

It can be provided, for example, that the first and the second information signal are in each case image signals and the preprocessing unit is designed to select only a predetermined selection of information from the image signal for the signal processing by means of the neural network, based on a function for which the respective image signal is provided. It can be provided, for example, that not all image frames of an information signal are processed, but only a part thereof (e.g. every second or every fifth frame). Image frames can be processed, for example, more frequently (e.g. more image frames, e.g. with a higher frequency) for more safety-relevant functions than for less safety-relevant functions. It can be provided, for example, that only every fifth (or tenth or twentieth) frame of the image signal is evaluated for less critical functions. A lower image recognition rate can also suffice, for example, for the driver fatigue detection function, whereas image frames must be evaluated more frequently (e.g. every second frame) for functions such as e.g. pedestrian detection. The frequency of frames to be evaluated can be selected depending on an image frequency of the camera.

It can be provided, for example, that the preprocessing unit is designed to select whether the first or the second separate unit of the neural network is used for the second signal processing step depending on the information signal present at the signal input. A respective identifier, for example, can be added to the information signal, indicating the signal source from which the information signal originates. It is then possible, by means of the identifier, to select whether the information signal is processed in the second signal processing step by means of the first or second separate unit of the neural network.

One aspect of the disclosure further relates to a system for processing an information signal. The system comprises a signal input for receiving the information signal and a shared unit of a neural network of the system, wherein the shared unit of the neural network is designed for a first signal processing step of the information signal.

The system further comprises at least two separate units of the neural network arranged in parallel in the signal flow downstream of the shared unit. The system is designed to use a first unit of the at least two separate units for a second signal processing step of the information signal in a first functional mode, and to use a second unit of the at least two separate units for a second signal processing step of the information signal in a second functional mode. A signal output of the system is designed to output the processed information signal.

The proposed system can advantageously enable the shared unit to be used for signal processing steps which are required for different functions (e.g. for the first and the second functional mode). In contrast to other systems, additional layers of the neural network can thereby be dispensed with, since they do not have to be designed in duplicate.

Conversely, the at least two separate units of the neural network (e.g. final layers of the neural network) which enable a downstream signal processing can be designed in a specialized manner for the respective function. For example, at least one of the separate units can be software-implemented (e.g. unlike a hardware design, it remains trainable even following implementation). The trainable final layers can be used, for example, if a first function is intended to be implemented with a signal from a sensor, and other, hardware-based final layers (e.g. of the second of the separate units of the neural network) can be used if a second function (e.g. different detection types) is intended to be implemented with the signal from the same sensor.

It can be provided, for example, that the system for parallel use of both the first and the second separate unit for the second signal processing step in order to effect a parallel execution of the first and the second functional mode.

One aspect relates to a sensor system. The sensor system comprises a system according to one of the systems described above or below. The sensor system further comprises at least two sensors which are connected to the signal input of the system. The at least two sensors are designed in each case to transmit different information signals to the signal input. A signal processing, for example, of information signals from the first sensor can advantageously be performed by means of the shared unit of the neural network of the system and a first unit of the separate units, and a signal processing of information signals from the second sensor can be performed by means of the shared unit of the neural network of the system and a second unit of the separate units. The sensor system can be designed as more efficient (e.g. more economical; e.g. smaller) through the shared use of the shared part of the neural network.

It can be provided, for example, that the at least two sensors comprise at least one of an optical sensor, a camera, a current sensor, a temperature sensor, a state-of-charge sensor or a sensor device designed to predict a recuperation event. Through the separation of the different elements of the neural network of the system, this can advantageously be used efficiently for a multiplicity of applications (e.g. classification of features from images; e.g. reduction of sensor data for an efficient further processing of the sensor data).

One aspect relates to a motor vehicle comprising a system according to one of the systems described above or below. The system is arranged in a control unit of the motor vehicle. The motor vehicle further comprises at least two sensors which are connected to the signal input of the system by means of an on-board power supply of the motor vehicle.

A constantly growing number of sensors, e.g. cameras, are used, particularly in motor vehicles. The proposed system can eliminate the need to provide a separate complete neural network for each sensor, but can enable at least partially shared use of neural networks or layers for a multiplicity of sensors. A more efficient signal processing in the vehicle can thereby be enabled.

One aspect relates to a method for signal processing of an information signal. A first method step relates to a processing of the information signal in a first signal processing step by means of a front unit of a neural network. A second method step relates to a determination of a type of the information signal and/or a provided function for which the information signal is used. A third method step relates to a further processing of the information signal in a second signal processing step by means of a first rear unit of the neural network by means of a second rear unit of the neural network, wherein the first rear unit or the second rear unit of the neural network is chosen depending on the type of the information signal and/or the provided signal processing function.

One of the proposed systems can be used, for example, in an efficient manner to carry out the proposed method. The use of the separate units of the neural network can enable a flexible selection for the signal processing of that unit which is most suitable for the signal to be processed and/or for a function assigned to the signal.

### BRIEF DESCRIPTION OF THE DRAWINGS

Exemplary embodiments are explained in detail below with reference to the attached figures, in which:

FIG. 1 shows a schematic example of a system for processing a first and a second information signal;

FIG. 2 shows a schematic example of a system for processing an information signal using a first or a second rear unit of a neural network;

FIG. 3 shows a schematic example of a method for processing an information signal; and

FIG. 4 shows an example of a sensor system having two cameras in a vehicle.

### DETAILED DESCRIPTION

Different exemplary embodiments will now be explained in more detail with reference to the attached drawings in which some exemplary embodiments are shown. In the figures, the thickness dimensions of lines, layers and/or regions may be shown in exaggerated form for the sake of clarity. In the following description of the attached figures, which merely show some generic exemplary embodiments, the same reference numbers can denote the same or comparable components.

One element which is referred to as “connected” or “coupled” with another element, can be directly connected or coupled with the other element, or intermediate elements can be present. Unless otherwise defined, all terms used herein (including technical and scientific terms) have the same meaning which an average person skilled in the art to which the exemplary embodiments belong ascribes to them.

Increasingly intensive use of applications with artificial intelligence (AI) or machine learning in the vehicle can result in an increasing energy requirement. One example of this would be automated driving in which a large number of sensors have to be evaluated. The evaluation of camera images, for example, using machine learning in object detection, object classification and/or segmentation plays an important role there.

Algorithms, for example, with convolutional neural networks (CNN) are designed for different camera systems in the vehicle which, in the case of other concepts with distribution among a plurality of control units and/or e.g. purely software-based implementation, results in an increased energy requirement and costs. The provision of energy for the execution of AI algorithms can represent an obstacle to the introduction of energy-efficient automated driving. Furthermore, according to other concepts, high hardware costs can be incurred due to the large number of additional control units.

Concepts are proposed below which can enable a reduction in the energy requirement and/or hardware costs. The illustrated example of automated driving is to be regarded only as an example. Proposed concepts can offer advantages for a multiplicity of applications. Use for implementations in the energy management sector using artificial intelligence, for example, is also worth mentioning here.

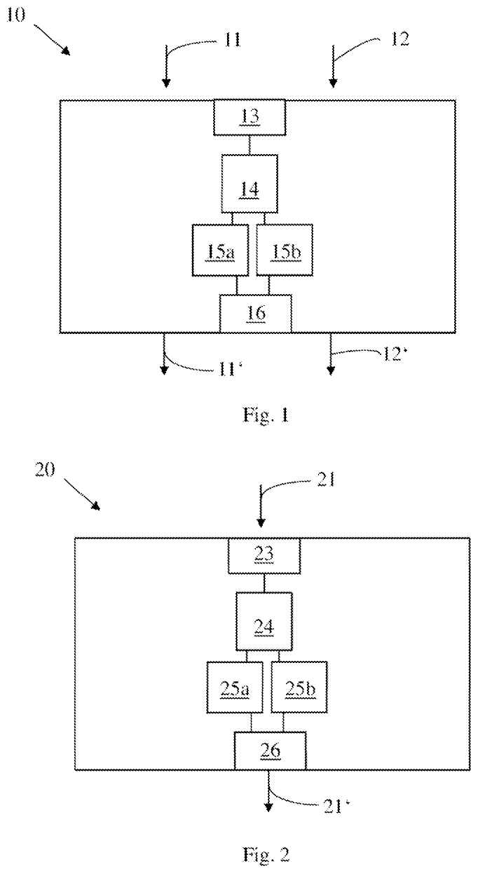

FIG. 1 shows a schematic example of a system 10 for processing a first and a second information signal 11, 12. The system 10 comprises a signal input 13 for receiving the information signals 11, 12.

The system 10 further comprises a neural network for data processing. A shared unit 14 of the neural network of the system 10 is designed for a respective first signal processing step of the information signals 11, 12. The information signals 11, 12 are received, for example, successively at the signal input 13. The shared unit 14 can then first carry out the first signal processing step for the first signal 11 and then the first signal processing step for the second signal 12. Alternatively, an optional preprocessing unit (see also FIG. 4) can provide a scheduling for the processing of the input signals by means of the shared unit 14.

The system 10 has at least two separate units 15a, 15b of the neural network arranged in the signal flow downstream of the shared unit 14, wherein a first unit 15a of the at least two separate units 15a, 15b is designed for a second signal processing step of the first information signal 11, and wherein a second unit 15b of the at least two separate units 15a, 15b is designed for a second signal processing step of the second information signal 12. The information signals 11′,12′ processed by the system 10 can be output at the signal output 16 of the system 10.

The example shows how, in a system 10 having a neural network, some layers can be used efficiently in a shared manner for processing different signals. The first signal 11, for example, can originate from a first sensor and the second signal 12 from a second sensor. The shared unit 14 can be designed to carry out processing steps for both signal types. In contrast to separate systems, this enables the elimination, for each of the two sensors, of a duplicate design of the layers of the neural network which are formed in the shared unit 14.

An optional control unit can determine, for example, the sensor from which the input signal respectively to be processed has been generated and can consequently control the separate unit 15a, 15b of the neural network by which the respective signal is intended to be processed in the second processing step.

Further details and aspects are mentioned in conjunction with the exemplary embodiments described above or below. The exemplary embodiment shown in FIG. 1 can have one or more optional additional features which correspond to one or more aspects which are mentioned in conjunction with the proposed concept or with one or more exemplary embodiments described above or below (e.g. FIG. 2-4).

FIG. 2 shows a schematic example of a system 20 for processing an information signal using a first unit 25a or a second unit 25b of a neural network of the system 20.

The system 20 comprises a signal input 23 for receiving the information signal 21, for example a signal from a sensor such as a camera. In particular, a plurality of signals from the sensor can be received and processed, e.g. for use in different functions (e.g. pedestrian detection, road sign detection, environment detection of a vehicle; and/or driver status detection, vehicle occupant detection).

A shared unit 24 of a neural network of the system 20 is designed for a first signal processing step of the information signal 21.

The system 20 further has at least two separate units 25a, 25b of the neural network arranged in parallel in the signal flow downstream of the shared unit 24. The system 20 is designed to use a first unit 25a of the at least two separate units 25a, 25b for a second signal processing step of the information signal 21 in a first functional mode, and to use a second unit 25b of the at least two separate units 25a, 25b for a second signal processing step of the information signal 21 in a second functional mode. The processed information signal 21′ can be output via a signal output 26.

A similar processing, for example, of the signals from the sensor (e.g. fundamental image processing steps) may be required for both the first and the second function of the system 20 (or for a plurality of further functions). This signal processing step can be carried out efficiently for both functions by means of the shared unit 24 of the neural network. Conversely, specific signal processing requirements of the functions can differ from one another. The first unit 25a of the separate units is therefore provided, for example, to continue or complete the signal processing for the first function, and the the first unit 25b of the separate units 25a, 25b is provided, for example, to continue or complete the signal processing for the second function. Here also, an efficient use of the layers (e.g. shared layers for both functions) of the neural network can again be performed in the shared unit 24.

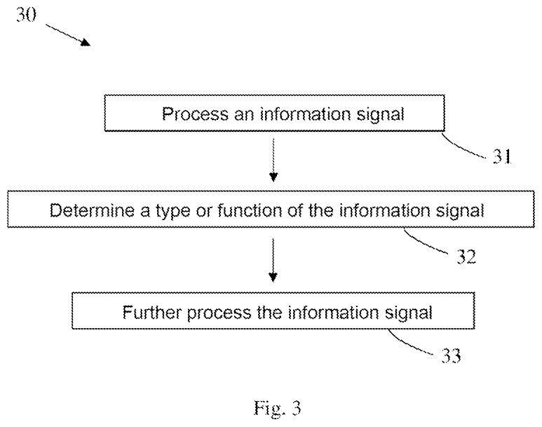

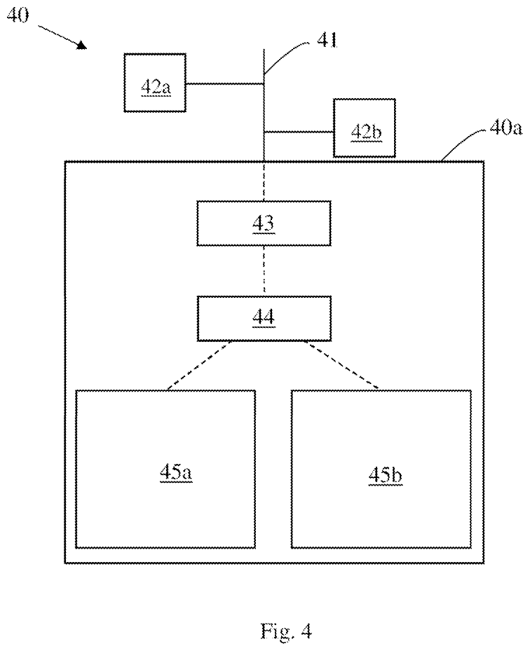

Further details and aspects are mentioned in conjunction with the exemplary embodiments described above or below. The exemplary embodiment shown in FIG. 2 can have one or more optional additional features which correspond to one or more aspects which are mentioned in conjunction with the proposed concept or with one or more exemplary embodiments described above (e.g. FIG. 1) or below (e.g. FIG. 3-4).

FIG. 3 shows a schematic example of a method 30 for the signal processing of an information signal. The method 30 comprises processing 31 the information signal in a first signal processing step by means of a front unit of a neural network. The method 30 further comprises determining 32 a type of the information signal (e.g. a signal source which has generated the information signal) and/or a provided function for which the information signal is used,

The method 30 further comprises further processing 33 the information signal in a second signal processing step my means of a first rear unit 15a of the neural network or by means of a second rear unit 15b of the neural network. The rear unit 15a, 15b of the neural network which is used for the second signal processing step is selected depending on the type of the information signal and/or the provided signal processing function.

Further details and aspects are mentioned in conjunction with the exemplary embodiments described above or below. The exemplary embodiment shown in FIG. 3 can have one or more optional additional features which correspond to one or more aspects which are mentioned in conjunction with the proposed concept or with one or more exemplary embodiments described above (e.g. FIG. 1-2) or below (e.g. FIG. 4).

FIG. 4 shows an example of a sensor system having two cameras 42a, 42b (e.g. generally sensors) in a vehicle 40, in particular a motor vehicle which is designed for (partially) automated driving.

The motor vehicle 40 comprises a system as described above or below which is arranged in a control unit 40a of the motor vehicle 40. The motor vehicle 40 further comprises at least two sensors 42a, 42b which are connected to the signal input of the system by means of an on-board power supply 41 of the motor vehicle 40.

The cameras 42a, 42b can comprise e.g. a front camera, a reversing camera, a side camera and/or an interior camera of the vehicle 40. The on-board power supply 41 can comprise a communication network in the vehicle 40, e.g. an Ethernet network, e.g. a LIN bus or CAN bus. The cameras 42a, 42b can, for example, provide the transmitted information signals with an identifier so that the information identifying the camera 42a, 42b from which the currently received information signal originates is available on the system. Alternatively, the signal input of the system can be designed to identify the camera 42a, 42b from which the information signal is transmitted and provide it with a corresponding identifier.

A preprocessing unit 43 is arranged in the control unit 40a between the signal input and a shared unit 44 of a neural network of the control unit. Said preprocessing unit 43 can comprise e.g. a hardware signal processing unit. The preprocessing unit 43 can be used to standardize the image signals from the different cameras in order to enable signal processing in a shared system. The image processed by the preprocessing unit 43 can, for example, be transmitted in a suitable size (e.g. resolution) and with normalization as a message with an identifier for the respective camera 42a, 42b to the shared unit 44 of the neural network.

The shared unit 44 of the neural network can comprise layers of the neural network which are used jointly by the different cameras 42a, 42b (e.g. shared between the different cameras 42a, 42b). These shared layers (e.g. of a convolutional neural network) can be implemented in hardware. The output signal of the shared unit 44 can be a feature map from the CNN or a vector following a flatten operation, e.g. with the identifier for the respective camera 42a, 42b.

By means of the identifier, it is possible to control (e.g. by means of a control unit—not shown) which of at least two separate units 45a, 45b of the neural network is used for the further signal processing (e.g. second signal processing step).

The first unit 45a of the two (or more) separate units 45a, 45b is implemented in software as trainable. The first unit 45a can comprise models of rear layers of a neural network (e.g. CNN and fully connected) e.g. for different tasks. The signals processed in this way can be used for segmentation, detection and/or classification.

The second unit 45b of the two (or more) separate units 45a, 45b is implemented in software as non-trainable. The second unit 45b can also comprise models of rear layers of a neural network (e.g. CNN and fully connected) e.g. for different tasks. The signals processed in this way can be used for segmentation, detection and/or classification.

The separate units 45a, 45b can in each case form a complete neural network, e.g. in combination with the shared unit 44. The shared use of layers of the neural network can increase efficiency. This can be the case, in particular, if a plurality (e.g. three, four or at least five) separate units (e.g. comprising final layers of the neural network) in each case share layers of the shared unit 44 with one another. The shared unit can comprise, for example, more layers than at least one of the separate units. The two separate units can, for example, have a different number of layers. The system can thus be used e.g. to process a multiplicity of a wide variety of sensors (e.g. cameras) and/or can be used for a wide variety of functions. If, for example, four separate units are used for the second signal processing step for a sensor, four different functions can be implemented.

A generic example of the use of the system is described below. Different camera systems record images for which algorithms such as object detection, object classification and segmentation can be executed. Since some tasks require redundant or similar algorithms, a dedicated control unit with a neural network does not exist e.g. for every person detection (front camera, interior camera). Convolutional layers of CNN can be interpreted as feature extraction methods. In one proposed concept, the convolutional layers of a trained CNN are implemented in hardware in a control unit (e.g. shared unit of the neural network). All tasks such as object detection, object classification and segmentation can use these shared convolutional layers (e.g. of the shared unit of the neural network) and can connect task-specific convolutional and fully connected neural networks thereto (e.g. separate units of the neural network). These networks can be implemented in software (e.g. trainable) or in hardware (e.g. non-trainable). If persons are detected and if this detection is intended to be performed on the one hand with the interior camera and also with the front camera, the advantage of the approach is evident through avoidance of redundancy in a manageable performance trade-off (e.g. the shared unit of the neural network can be used for the shared task in the signal processing; e.g. the preprocessing unit can enable a time division of the signal processing by means of the shared unit of the neural network).

The described concept of the shared neural network layers is not restricted to image processing and is used here merely for illustrative purposes. For example, the proposed concept can be used e.g. in energy management also, e.g. through shared autoencoder layers for dimensionality reduction (e.g. data reduction).

Further details and aspects are mentioned in conjunction with the exemplary embodiments described above or below. The exemplary embodiment shown in FIG. 4 can have one or more optional additional features which correspond to one or more aspects which are mentioned in conjunction with the proposed concept or with one or more exemplary embodiments described above (e.g. FIG. 1-3).

Examples relates to a method and a system for the energy-efficient implementation of machine learning for e.g. image processing in automated driving with simultaneous cost reduction. The use of shared-use layers and also separate layers of neural networks (e.g. for different signal types or applications) in a single system can bring about an efficiency gain compared with conventional systems.

Proposed aspects can enable higher energy efficiency by reducing the number of control units and through hardware implementation of convolutional layers. A cost reduction can further be achieved by reducing the number of control units and by means of shared convolutional layers.

1.-17. (canceled)

18. A system for processing at least a first information signal and a second information signal, the system comprising:
a signal input configured to receive at least the first information signal and the second information signal;
a shared unit of a neural network of the system, wherein the shared unit of the neural network is configured to perform a respective first signal processing step of the first information signal and the second information signal;
at least two separate units of the neural network arranged in the signal flow downstream of the shared unit, wherein a first unit of the at least two separate units is configured to perform a second signal processing step of the first information signal, and wherein a second unit of the at least two separate units is configured to perform a second signal processing step of the second information signal, to generate processed information signals; and
a signal output configured to output the processed information signals.

19. The system as claimed in claim 18, wherein the at least two separate units of the neural network comprise at least one software-implemented unit of the neural network and at least one hardware-implemented unit of the neural network.

20. The system as claimed in claim 20, wherein the at least two separate units of the neural network are disposed in parallel in the signal flow.

21. The system as claimed in claim 18, wherein the at least two separate units of the neural network are disposed in parallel in the signal flow.

22. The system as claimed in claim 18, wherein the shared unit of the neural network is hardware-implemented.

23. The system as claimed in claim 22, wherein the at least two separate units of the neural network comprise at least one software-implemented unit of the neural network and at least one hardware-implemented unit of the neural network.

24. The system as claimed in claim 23, wherein the at least two separate units of the neural network are disposed in parallel in the signal flow.

25. The system as claimed in claim 18, wherein the shared unit of the neural network comprises a convolutional neural network.

26. The system as claimed in claim 18, wherein the shared unit of the neural network comprises an autoencoder.

27. The system as claimed in claim 18, the system further comprising:
a preprocessing unit;
wherein the preprocessing unit is arranged in the signal flow between the signal input and the shared unit of the neural network,
wherein the preprocessing unit is configured to allocate a respective processing time to the first information signal and the second information signal for the first signal processing step by the shared unit of the neural network.

28. The system as claimed in claim 27, wherein the preprocessing unit is configured to convert the first information signal and the second information signal to a signal standard which is adapted to the shared unit of the neural network.

29. The system as claimed in claim 28, wherein the first information signal and the second information signal are image signals and the preprocessing unit is configured to convert the image signals into the respective standard image signals with a predetermined frame rate and/or a predetermined image resolution.

30. The system as claimed in claim 29, wherein the preprocessing unit is further configured to make only a predetermined selection of information from the at least a first image signal of the image signals for the signal processing by the shared unit based on a function for which the first image signal is provided.

31. The system as claimed in claim 27, wherein the preprocessing unit is configured to select whether the first unit or the second unit of the neural network is used for the second signal processing step depending on the first information signal or the second information signal present at signal input.

32. A system for processing an information signal, the system comprising:
a signal input configured to receive the information signal;
a shared unit of a neural network of the system, wherein the shared unit of the neural network is configured to perform a first signal processing step of the information signal;
at least two separate units of the neural network arranged in parallel in the signal flow downstream of the shared unit, wherein the system is configured to use a first unit of the at least two separate units for a second signal processing step of the information signal in a first functional mode, and to use a second unit of the at least two separate units for a second signal processing step of the information signal in a second functional mode, to generate a processed information signal; and
a signal output configured to output the processed information signal.

33. The system as claimed in claim 32, wherein the system is configured for parallel use of both the first and the second separate unit for the second signal processing step in order to effect a parallel execution of the first and the second functional mode.

34. A sensor system comprising:
a system as claimed in claim 1; and
at least two sensors which are connected to the signal input of the system,
wherein the at least two sensors are configured to transmit different information signals to the signal input.

35. The sensor system as claimed in claim 34,
wherein the at least two sensors comprise at least one of an optical sensor, a camera, a current sensor, a temperature sensor, a state-of-charge sensor or a sensor device configured to predict a recuperation event.

36. A motor vehicle comprising:
a system as claimed in claim 1 which is arranged in a control unit of the motor vehicle; and
at least two sensors which are connected to the signal input of the system using an on-board power supply of the motor vehicle.

37. A method for the signal processing of at least one information signal, the method comprising:
processing the information signal in a first signal processing step using a front unit of a neural network;
determining a type of the information signal and/or a provided function for which the information signal is used; and
further processing the information signal in a second signal processing step using a select one of a first rear unit of the neural network or a second rear unit of the neural network, wherein selection of the first rear unit or the second rear unit of the neural network is made depending on the type of the information signal and/or the provided signal processing function.
